(19) United States
(12) Patent Application Publication
(10) Pub. No.: US 2024/0161022 A1
(43) Pub. Date: May 16, 2024

(54) FAST AND FLEXIBLE HOLOMORPHIC EMBEDDING METHOD AND APPARATUS FOR ECONOMIC STRATEGY ADJUSTMENT

(71) Applicant: SUN YAT-SEN UNIVERSITY, Guangzhou (CN)

(72) Inventors: Tao WANG, Guangzhou (CN); Yusi ZHANG, Guangzhou (CN); Wen ZHANG, Guangzhou (CN); Jiamin ZHANG, Guangzhou (CN); Yanzhi LIU, Guangzhou (CN)

(73) Assignee: SUN YAT-SEN UNIVERSITY, Guangzhou (CN)

(21) Appl. No.: 18/405,880

(22) Filed: Jan. 5, 2024

Related U.S. Application Data
(63) Continuation of application No. PCT/CN2022/094900, filed on May 25, 2022.

(30) Foreign Application Priority Data
Jul. 12, 2021 (CN) 2021107842176

(51) Int. Cl. G06Q 10/04; G06F 17/11

(52) U.S. Cl. CPC G06Q 10/04; G06F 17/11

(57) ABSTRACT

Disclosed in the present invention is a fast and flexible holomorphic embedding method and apparatus for economic strategy adjustment. The method includes: obtaining product data and establishing equilibrium polynomial equations based on a Bertrand model; describing the equilibrium polynomial equations as a polynomial system and constructing a polynomial homotopy function; solving the equilibrium polynomial equations to obtain solutions of the equations: and analyzing equilibriums based on the solutions of the equations and performing economic strategy selection. The apparatus includes a memory and a processor configured to perform the fast and flexible holomorphic embedding method for economic strategy adjustment. The present invention can efficiently solve equilibrium polynomial equations based on which an economic strategy can be adjusted, to improve performance of enterprises. The fast and flexible holomorphic embedding method and apparatus for economic strategy adjustment provided by the present invention can be used extensively in the field of strategy adjustment.

### CROSS-REFERENCE TO RELATED APPLICATIONS

The application claims priority to Chinese patent application No. 2021107842176, filed on Jul. 12, 2021, the entire contents of which art incorporated herein by reference,

### TECHNICAL FIELD

The present invention is related to the field of strategy adjustment, and in particular, to a fast and flexible holomorphic embedding method and apparatus for economic strategy adjustment.

### BACKGROUND

In fields in which economic analysis is actively used nowadays, static and dynamic games are important instruments for analyzing strategic interactions between economic entities and have been used extensively in economics. In many economic models or even games, an equilibrium may be described as a solution of a polynomial system, so that all cases of equilibriums can be obtained through analysis for selecting a corresponding strategy. A conventional method for analyzing an equilibrium needs to consume a huge amount of computing resources, causing difficulties for enterprises in adjusting economic strategies in the right time and generating maximal profit.

### SUMMARY

To resolve the foregoing technical problem, the objective of the present invention is to provide a fast and flexible holomorphic embedding method and apparatus for economic strategy adjustment, to efficiently solve polynomial equations according to a fast and flexible holomorphic embedding method based on an are-length parametrization, so that strategy selection can be performed by assessing and analyzing all cases of equilibriums in equilibrium solutions.

A first technical solution used in the present invention is a fast and flexible holomorphic embedding method for economic strategy adjustment, including the following steps:

S1: obtaining product data and establishing equilibrium polynomial equations based on a Bertrand model;

S2; describing the equilibrium polynomial equations as a polynomial system and constructing a polynomial homotopy function;

S3: solving the equilibrium polynomial equations to obtain solutions of the equations; and

S4: analyzing equilibriums based on the solutions of the equations and performing economic strategy selection,

Further, an expression of the equilibrium polynomial equations: s as follows:

$$\{ \begin{matrix}{Z}^{2} {p}_{x}^{2} {p}_{y}^{2} - {p}_{x}^{2} - {p}_{y}^{2} = 0 \\ 2 {Z}^{3} {p}_{x}^{7} - 51 {Z}^{3} {p}_{x}^{6} + 5400 {Z}^{2} {p}_{x}^{3} - 8100 {Z}^{2} {p}_{x}^{2} - 2700 {p}_{x} + 2700 = 0 ; \\ 2 {Z}^{3} {p}_{y}^{7} - 51 {Z}^{3} {p}_{y}^{6} + 5400 {Z}^{2} {p}_{y}^{3} - 8100 {Z}^{2} {p}_{2}^{y} - 2700 {p}_{y} + 2700 = 0\end{matrix}$$

to in the expression, each of x and y represents a corresponding product, pₓ represents a price of the product x, p_{y} represents a price of the product y, Z represents a new variable derived from pₓ and p_{y}.

Further, x=(x₁, x₂, . . . , xₙ)^{T}, f(x)=[f₁(x), f₂(x), . . . , fₙ(x)]^{τ}, and an expression of the polynomial homotopy function is as follows:

H(x, t)=(2−t)g(x)+(t−1)f(x);

in the expression, f(x) represents a polynomial function on the left of the equilibrium polynomial equations, or another polynomial function to be solved, and g(x) is a polynomial function constructed according to a total-degree method or a simple function constructed by another manner.

Further, the step of solving the equilibrium polynomial equations to obtain solutions of the

equations specifically includes:
S21: initializing and setting an order qₘₐₓ for a partial sum of a power series, a threshold r of a mismatch tolerance for both sides of an equation, and an upper hound sₘₐₓ for an arc length of each extension, and at t=1, solving a real solution of H(x, t)=g(x) as a corresponding initial point X₀=(x₁(0), x₂(0), . . . , xₙ(0), t(0));
S22: introducing a parameter s, and selecting a normalization equation for an arc-length parametrization with the polynomial homotopy function, to construct an embedding system;
S23: providing as power series of xₖ(s), k=1,2, . . . , n, t(s) using s as a parameter and substituting the power series into the embedding system, to obtain an equation in which coefficients of a power series expansion are used as unknown variables, solving the coefficients of the power series, by using a logarithmic (log) method, and performing searching-direction selection on a curve by a tangent matching principle:

S24: substituting a value of rational function at s=s₀ into the embedding system by using a method computing the value of rational function by a ratio of matrix determinants, to obtain a mismatch between values at left and right sides of the equation;

S25: reducing s₀ and returning to step S24 when determining that the mismatch between the values at the left and right sides of the equation is not less than a preset threshold, and repeating the process until the mismatch between the values at the left and right sides of the equation is less than the preset threshold;

S26: recording s̅₀̅=s₀, and using xₖ, (s̅₀̅) (k=1, . . . , n), t(s̅₀̅) as a new initial point X₀;

S27: determining that t≥2, solving s=when t(s)=2 and substituting s=s̅ into a latest power series expansion of xₖ, and obtaining a numerical value xₖ(s̅) (k=1, . . . , n), to obtain a solution of the equations; and

S28; determining a saddle-node bifurcation (SNB) point on a corresponding curve by calculating an extreme point of an approximation function of t(s).

Further, an expression of the embedding system is as follows:

$${\sum }_{k = 1}^{n} \{ {( \frac{{dx}_{k}}{ds} )}^{2} ( s ) \} + {( \frac{dt}{ds} ( s ) )}^{2} = 1 ,$$

$$H ( x , t ) = 0$$

in the expression, s is an arc length parameter, x=(x₁, x₂, . , , , xₙ)^{T} is a variable to he solved, and t is a variable introduced to devise a homotopy function H.

Further, an expression of a power series expansion of xₖ is as follows:

xₖ(s)=Σ_{1≥0}a_{q}^{x}^{ₖ}s^{q}

in the expression, s is the arc length parameter, and a_{q}^{x}^{ₖ}s^{q}(q≥0) is the coefficient of the power series expansion.

The method further includes:
constructing an augmented system of equations for a corresponding variable based on constraint conditions, and obtaining a solution for f(x)=0 subject to certain constraint conditions,

The method further includes:
performing fast equation solving by using a separation method when there is a complex solution of the polynomial equations.

Further, the step of analyzing equilibriums based on the solutions of the equations and performing economic strategy selection specifically includes:
removing the negative solutions in the solutions of the equations; and
when a second-order condition for profit is satisfied and a strategy made by another given participant is also satisfied, selecting a solution that generates a maximal profit in a set of candidate equilibriums.

A second, technical solution used in the present invention is a fast and flexible holomorphic embedding apparatus for economic strategy adjustment, including:
at least one processor; and
at least one memory, configured to store at least one program, where
when the at least one program is executed by the at least one processor, the at least one processor is enabled to implement the fast and flexible holomorphic embedding method for economic strategy adjustment described above.

The beneficial effect of the method and the apparatus in the present invention is that a corresponding economic model and polynomial equations can he constructed based on an actual case of an enterprise, the polynomial equations can he efficiently solved based on an arc-length parametrization and a curve tracing method using piecewise rational function approximation, and a corresponding economic strategy satisfying a restriction can be selected by ,assessing and analyzing all cases of equilibriums in equilibrium solutions, to boost the enterprise profit,

### BRIEF DESCRIPTION OF DRAWINGS

FIG. 1 is a schematic diagram of economic strategy adjustment by using a fast and flexible holomorphic embedding method for economic strategy adjustment according to the present invention;

FIG. 2A and FIG. 2B are a schematic diagram of a tact and flexible holomorphic embedding

method for economic strategy adjustment according to a specific embodiment of the present invention;

FIG. 3 shows a logarithmic (log) method for solving polynomial equations for real solutions according to a specific embodiment of the present invention;

FIG. 4 slims a process floss of calculating a saddle-node bifurcation (SNB) point on a curve. according to a specific embodiment of the present invention; and

FIG. 5 shows a process flow of a variable separation method for solving polynomial equations for a complex solution according to a specific embodiment of the present invention,

### DETAILED DESCRIPTION OF THE EMBODIMENTS

The present invention is further described in detail below in conjunction with the accompanying drawings and specific embodiments. Serial numbers of steps in the following embodiments are merely for description and explanation, and do not constitute any limitation on a sequence of the steps, An execution sequence of each step in the embodiments may be adaptively adjusted based on understanding of a person skilled in the art.

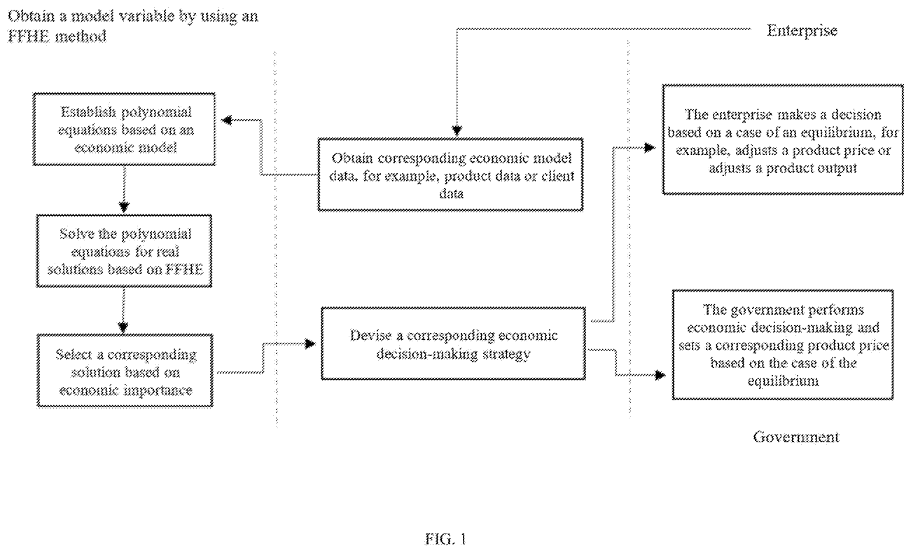

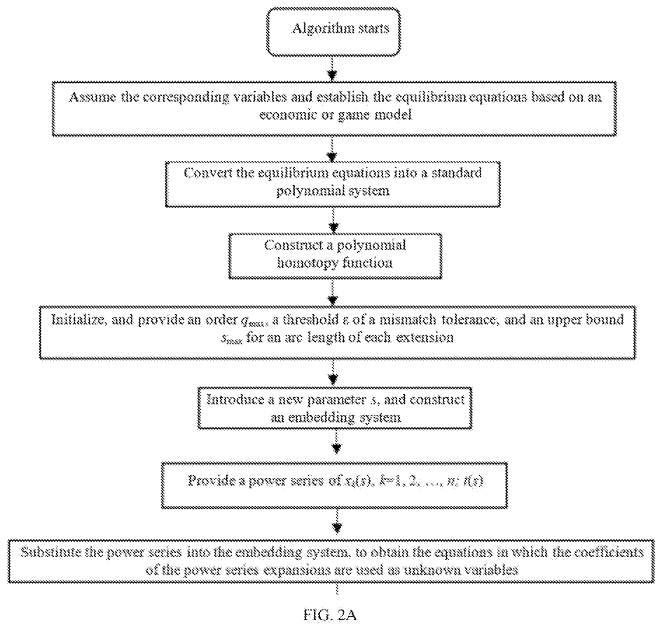

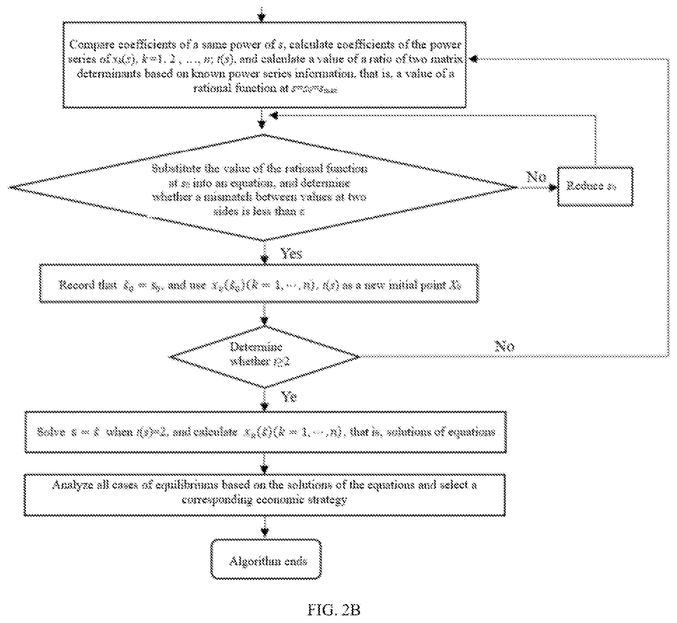

As shown in FIG. 1 and FIG. 2, the present invention provides a fast and flexible holomorphic embedding method for economic strategy adjustment. The method includes the following steps:
S1: obtaining product data and establishing equilibrium polynomial equations based on a Bertrand model;
S2: describing the equilibrium polynomial equations as a polynomial system and constructing a polynomial homotopy function.

Specifically, the Bertrand model is used as an example to describe a process of constructing a polynomial system based on an economic; model. There are two types of products; x and y. enterprise x(y) produces the product x(Y), and there are three types of clients. pₓ(p_{y}) is a price of the product x(y). Dₓ^{l}(D_{y}^{l}) is a quantity of the, product x(y) demanded by a type i client, and i=1,2,3, A type I client demands only the product x with a linear demand curve. Therefore:

Dₓ¹=A−pₓ, D_{y}¹=0; and
a type 3 client demands only the product y with a linear demand curve. Therefore:

Dₓ³=0, D_{y}⁴=A−p_{y};

A is a constant, A type 2 client demands both the two types of products. A quantity of type 2 clients is n. Assume that the two types of products are not imperfect substitutes for the type 2 client, an elasticity of substitution between the two types of products .is constant, and an elasticity of demand of a composite commodity is constant. That is:

Dₓ²=npₓ^{-σ}(pₓ^{1-σ}+p_{y}^{1-σ})^{(γ-σ)/(-1+σ)},

D_{y}²=np_{y}^{-σ}(pₓ^{1-σ}+p_{y}^{1-σ})^{(γ-σ)/(-1+σ)};

σ is the elasticity of substitution between x and y, and γ is the elasticity of demand of the composite commodity. Therefore, aggregate demand is as follows:

Dₓ=Dₓ¹+Dₓ²+Dₓ³, and

D_{y}=D_{y}¹+D_{y}²+D_{y}³;

a unit cost of production of each enterprise is in. A profit of the product x is Rₓ=(pₓ−m)Dₓ, and MRₓ is a marginal profit of the product x. R_{y}, MR_{y} are defined similarly Therefore, an equilibrium price satisfies a condition: MRₓ=MR_{y}=0. Assume that corresponding parameters are σ=3, y=2, n=2700, m=1,A=50. Therefore, marginal profit functions are as follows:

$${MR}_{x} = ( 50 - {p}_{x} ) + ( {p}_{x} - 1 ) ( - 1 + \frac{2700}{{{p}_{x}^{6} ( {p}_{x}^{- 2} + {p}_{y}^{- 2} )}^{3 / 2}} - \frac{8100}{{{p}_{x}^{4} ( {p}_{x}^{- 2} + {p}_{y}^{- 2} )}^{1 / 2}} ) + \frac{2700}{{{p}_{x}^{3} ( {p}_{x}^{- 2} + {p}_{y}^{- 2} )}^{1 / 2}} , \\ {MR}_{y} = ( 50 - {p}_{y} ) + ( {p}_{y} - 1 ) ( ( - 1 + \frac{2700}{{{p}_{y}^{6} ( {p}_{x}^{- 2} + {p}_{y}^{- 2} )}^{3 / 2}} - \frac{8100}{{{p}_{y}^{4} ( {p}_{x}^{- 2} + {p}_{y}^{- 2} )}^{1 / 2}} ) + \frac{2700}{{{p}_{y}^{3} ( {p}_{x}^{- 2} + {p}_{y}^{- 2} )}^{1 / 2}} ;$$

as the above equations are not polynomial equations, the equations need to be converted into standard polynomial equations. Define.:

Z=(pₓ⁻²+p_{y}⁻²)^{1/2}

Therefore, the following polynomial equations are obtained:

$$\{ \begin{matrix}{Z}^{2} {p}_{x}^{2} {p}_{y}^{2} - {p}_{x}^{2} - {p}_{y}^{2} = 0 \\ 2 {Z}^{3} {p}_{x}^{7} - 51 {Z}^{3} {p}_{x}^{6} + 5400 {Z}^{2} {p}_{x}^{3} - 8100 {Z}^{2} {p}_{x}^{2} - 2700 {p}_{x} + 2700 = 0 \\ 2 {Z}^{3} {p}_{y}^{7} - 51 {Z}^{3} {p}_{y}^{6} + 5400 {Z}^{2} {p}_{y}^{3} - 8100 {Z}^{2} {p}_{y}^{2} - 2700 {p}_{y} + 2700 = 0\end{matrix} ;$$

The polynomial equations may be described as a polynomial system f(x)=0,x=(pₓ, p_{y}, Z)^{T}.

pₓ(p_{y}) is a price of the product x(y) in equilibrium, so that the enterprise profits Rₓ, R_{y} are maximal profits. To be specific, when a second-order condition for profit is satisfied and a strategy made by another given participant is also satisfied, a maximal profit is generated in the set of candidate equilibriums.

S3; solving the equilibrium polynomial equations to obtain solutions of the equations;

S4: analyzing equilibriums based on the solutions of the equations and performing economic strategy selection.

Further, as an embodiment of the method, it is assumed that a polynomial system to he solved is f(x)=0, where x=(x₁, x₂, . . . ,xₙ)^{T}, f(x)=[f₁(x), f₂(x), . . . fₙ(x)]^{T}, and an expression of the polynomial homotopy function is as follows:

H(x, t)=(2−t)g(x)+(t−1)f(x); (1)

in the expression, g(x)=[g₁(x), g₂(x), . . . , gₙ(x)]^{T}.

Further, as an embodiment of the method, the step of solving the equilibrium polynomial equations to obtain solutions of the equations specifically includes:

S21: initializing and setting an order qₘₐₓ for a partial sum of a power series, a threshold ε of a mismatch tolerance for both sides of an equation, and an upper bound sₘₐₓ for an arc length of each extension, and at t=1, solving a real solution of H(x, t)=g(x) as a corresponding initial point X₀=(x₁(0), x₂(0), . . . , xₙ(0), t(0));

S22: introducing a parameter s, and selecting a normalization equation for the arc-length

parametrization with the polynomial homotopy function, to construct an embedding system.

$${\sum }_{k = 1}^{n} \{ {( \frac{{dx}_{k}}{ds} )}^{2} ( s ) \} + {( \frac{dt}{ds} ( s ) )}^{2} = 1 , \\ H ( x ( s ) , t ( s ) ) = 0 ; \qquad ( 2 )$$

S23: providing a power series of xₖ(s), k=1,2, . . . n, t(s) using s as a parameter and substituting the power series into the embedding system, to obtain an equation in which coefficients of a power series expansion are used as unknown variables, solving the coefficients of the power series, by using a logarithmic (log) method, and performing searching-direction selection on a curve by a tangent matching principle.

Specifically, the power series using s as a parameter is xₖ(s)=Σ_{q≥0}a_{q}^{x}^{ₖ}s^{q}, k=1,2, . . . , n; t(s)=Σ_{1≥0}a_{q}^{x}^{ₙ₊₁}s^{q} and the linear equations are obtained when q≥2 (that is, more than second-order terms) by using the logarithmic (log) method. As the matrix of one tracing of the linear equations is fixed, it can efficiently reduce the time for solving the linear equations.

in addition, according to the tangent matching principle, the searching-direction of the subsequent curve segment is selected based on the direction of a tangent line of a previous segment at a last point to ensure smoothness of the traced curve.

The equations in which the coefficients of the power series a used as the unknown variables are as follows:

$${\sum }_{k = 1}^{n + 1} \{ {( {\sum }_{q \geq 0} ( 1 + q ) \cdot {a}_{q + 1}^{{x}_{k}} {s}^{q} )}^{2} \} = 1 , \\ H ( {\sum }_{q \geq 0} {a}_{q}^{{x}_{1}} {s}^{q} , {\sum }_{q \geq 0} {a}_{q}^{{x}_{2}} {s}^{q} , … , {\sum }_{q \geq 0} {a}_{q}^{{x}_{n + 1}} {s}^{q} ) = 0 ;$$

in the expression, s is the arc length parameter, and a_{q}^{x}^{_{q}}(q≥0, k=1,2 . . . , n+1) is the coefficient of the power series expansion.

First, coefficients rat a same power of s are compared, and for a₀^{x}^{ₖ}(k=1, . . . , n+1):

a₀^{x}^{ₖ}=xₖ(0), k=1, . . . , n; a₀^{x}^{ₙ₊₁}=t(0); and

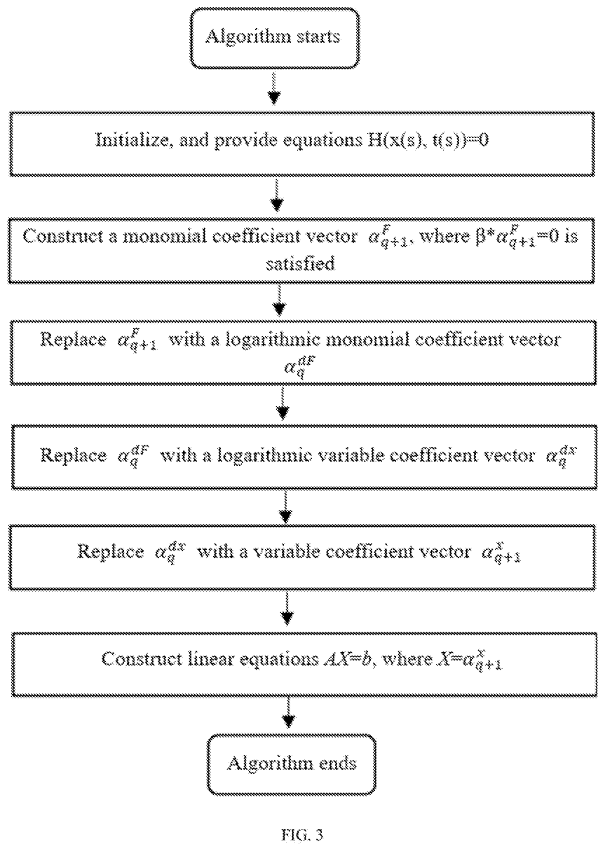

The equations H(x(s), t(s))=0 are reduced to the linear equations. Specific steps of the logarithmic (log) method are enlisted herein, as shown in FIG. 3.

It is specified that t(s)=xₙ₊₁(s), and for each monomial f(s)=Πₖ(xₖ(s))^{α}^{ₖ}, it is assumed that the following three expressions can be satisfied:

$$\frac{{f}^{′} ( s )}{f ( s )} = {\sum }_{q \geq 0} {a}_{q}^{df} {s}^{q} = \frac{{\sum }_{q \geq 0} ( q + 1 ) {a}_{q + 1}^{f} {s}^{q}}{{\sum }_{q \geq 0} {α}_{q}^{f} {s}^{q}} ; \qquad ( 3 )$$

$$\frac{{x}_{k}^{′} ( s )}{{x}_{k} ( s )} = {\sum }_{q \geq 0} {a}_{q}^{{dx}_{k}} {s}^{q} = \frac{{\sum }_{q \geq 0} ( q + 1 ) {a}_{q + 1}^{{x}_{k}} {s}^{q}}{{\sum }_{q \geq 0} {a}_{q}^{{x}_{k}} {s}^{q}} ; \qquad ( 4 )$$

$${a}_{q}^{df} = {\sum }_{k = 1}^{n} {α}_{k} {a}_{q}^{{dx}_{k}} ; \qquad ( 5 )$$

To obtain (q+1)^{th} power coefficients of the power series expansions, for each polynomial:

$$F ( s ) = {\sum }_{j = 1}^{m} {β}_{j} {f}_{j} ( s ) = {\sum }_{j = 1}^{m} {β}_{j} * {\prod }_{k = 1}^{n + 1} {( {x}_{k} ( s ) )}^{{α}_{jk}} ,$$

a monomial coefficient vector a_{q+1}^{F} satisfies:

β*a_{q+1}^{F}=0 (6)

β=(β₁. . . , βₘ), a_{q+1}^{F} =(a_{q+1}^{f}^{₁}, . . . , a_{q+1}^{f}^{ₘ})^{T} is a coefficient vector of the (q+1)^{th} power of the monomials series expansions.

Linear equations are obtained combining (3), (4), (5), and (6):

AX=b; (7)

X=(a_{q+1}^{x}^{₁}, . . . , a_{q+1}^{x}^{ₙ₊₁})^{T}, A is an n×(n+1) order matrix, and b is n-dimensional column vector.

For a₁^{x}^{ₖ}(k=1, . . . n+1), the following equations are constructed:

$${\sum }_{k = 1}^{n + 1} {( {a}_{1}^{{x}_{k}} )}^{2} = 1 ; \qquad ( 8 )$$

$$AX = b ; \qquad ( 9 )$$

Herein, X =(a₁^{x}^{₁}, . . . , a₁^{x}^{ₙ₊₁})^{T}.

(8) and (9) are reduced to a quadratic equation with one unknown variable a₁^{x}^{ₙ₊₁};

c₀(a₁^{x}^{ₙ₊₁})²+c₁a₁^{x}^{ₙ₊₁} c₂=0;

c₀, c₁, and c₂ may be calculated based on A and b. To select one solution of a₁^{x}^{ₙ₊₁}, it is specified;

$${\tilde{x}}_{2 , 1} = \frac{1}{2 {c}_{0}} \cdot ( - {c}_{1} + \sqrt{{c}_{1}^{2} - 4 {c}_{0} {c}_{2}} ) , \\ {\tilde{x}}_{2 , 2} = \frac{1}{2 {c}_{0}} \cdot ( - {c}_{1} - \sqrt{{c}_{1}^{2} - 4 {c}_{0} {c}_{2}} ) ;$$

for a first time of solving, a_{q}^{x}^{_{q}}=cy is used, and for the other tithe of solving, directions of \tilde{x}_{2,1} and \tilde{x}_{2,2} are determined. it is specified that a value of dt₀ is obtained in step S309, and if \tilde{x}_{2,1}*dt₀>0, a₁^{x}^{ₙ₊₁}=\tilde{x}_{2,1}; otherwise, a₁^{x}^{ₙ₊₁}=\tilde{x}_{2,2}.

As equations satisfied by a_{q}^{x}^{ₖ}(k=1, . . . , n+1; q=2, . . . , qₘₐₓ) are linear equations, a classical method may be used for efficiently solving.

S24: substituting a value of rational function at s=s₀ into the embedding system by using a method computing the value of rational function by a ratio of matrix determinants, to obtain a mismatch between values at left and right sides of the equation.

in addition, the method may be replaced with a method in which coefficients of a rational approximation fraction are calculated based on the coefficients of the power series expansion,

S25: reducing s₀ and returning to step S24 when determining that the mismatch between the values at the left and right sides of the equation is not less than a preset threshold, and repeating the process until the mismatch between the values at the left and right sides of the equation is less than the preset threshold.

Specifically, it is specified that s₀=sₘₐₓ, based on power series information of xₖ(s)(k=1, . . . , n), t(s), two determinants for calculating a value of a rational approximation function at s=s₀ are constructed as follows:

$${𝒫}_{k}^{L , M} ( s ) = \vert \begin{matrix}{a}_{L - M + 1}^{{x}_{k}} & {a}_{L - M + 2}^{{x}_{k}} & … & {a}_{L + 1}^{{x}_{k}} \\ ⋮ & ⋮ & ⋱ & ⋮ \\ {a}_{L}^{{x}_{k}} & {a}_{L + 1}^{{x}_{k}} & … & {a}_{L + M}^{{x}_{k}} \\ {S}^{M} & {S}^{M - 1} & … & 1\end{matrix} \vert \\ {𝒬}_{k}^{L , M} ( s ) = \vert \begin{matrix}{a}_{L - M + 1}^{{x}_{k}} & {a}_{L - M + 2}^{{x}_{k}} & … & {a}_{L + 1}^{{x}_{k}} \\ ⋮ & ⋮ & ⋱ & ⋮ \\ {a}_{L}^{{x}_{k}} & {a}_{L + 1}^{{x}_{k}} & … & {a}_{L + M}^{{x}_{k}} \\ {\sum }_{j = M}^{L} {a}_{j - M}^{{x}_{k}} {s}^{j} & {\sum }_{j = M - 1}^{L} {a}_{j - M + 1}^{{x}_{k}} {s}^{j} & … & {\sum }_{j = 0}^{L} {a}_{j}^{{x}_{k}} {s}^{j}\end{matrix} \vert$$

L+M=qₘₐₓ, L, M≥0, and when j<0, aⱼ^{x}^{ₖ}=0. value at s=s₀ is calculated with a value of a determinant ratio

$$\frac{{𝒫}_{k}^{L , M} ( s )}{{𝒬}_{k}^{L , M} ( s )} .$$

In addition, a value of

$$\frac{dt}{ds}$$

at s=s₀ may be calculated using the different method or another method, and may be denoted as dt₀.

The value at s=s₀ is substituted into the equation (2), and whether the mismatch between 10 values at the left and right sides of the equation is less than a preset allowable threshold ε is determined. if the mismatch is less than the threshold, it is recorded that \tilde{s}₀=s₀; otherwise, s₀ reduced, until. the mismatch is less than the threshold, and \tilde{s}₀ is finally recorded. To be specific, s₀ is found as large as possible so that the maximal mismatch at it is less than the threshold ε,

S26: recording s̅₀̅=s₀, and using xₖ(s̅₀̅) (k=1, . . . , n), t(s̅₀̅) as a new initial point: X₀,

S27: determining that t≥obtaining s=s̅ when t(s)=2 and substituting s=s̅

into the latest power series expansion of xₖ, and obtaining a numerical value xₖ(s̅)(k=1, . . . , n), to obtain a solution of the equation.

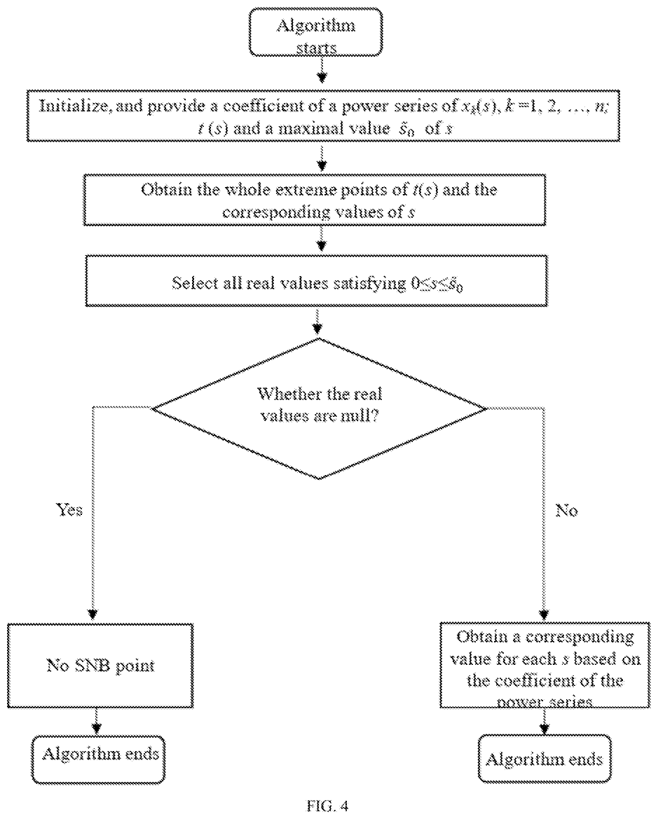

S28: as shown in FIG. 4, by calculating an extreme point of power series of each t expansion:

t(S)=E_{q≥0}a_{q}^{x}^{ₙ₊₁}s^{q},

or a rational approximation function of the power series, a corresponding SNB point determined.

Further, as an embodiment of the method, the step of analyzing equilibriums based on the solutions of the equations and performing economic strategy selection specifically includes:
removing the negative solutions in the solutions of the equations, where
specifically, a solution through calculation needs to satisfy non-negativity in terms of economy, and therefore the negative solutions may be removed, or it may conic down to solving polynomial equations subject to certain constraint conditions; and if an augmented system of equations for a corresponding variable based on constraint conditions is to be constructed, this step of removing the negative solutions may be skipped; and
when a second-order condition for profit is satisfied and a strategy made by another given participant is also satisfied, selecting a solution that generates a maximal profit in a set of candidate equilibriums.

Specifically, the second-order condition for the enterprise profit is checked. That is, the second-order derivative of the profit function is negative, and all candidate equilibriums, of enterprises, that do not satisfy the second-order condition are removed, In this example, the second- order derivative of Rₓ,R_{y} are both negative; and the global optimality , each remaining candidate equilibrium of each enterprise is checked. With the strategy made by the another given participant, and a global maximal value has to satisfy a first-order condition. Therefore, all solutions satisfying the first-order condition of the enterprise are found in the candidate equilibrium condition, and the solution generating the highest profit is finally selected. Only if the candidate equilibrium is the global maximal value, an equilibrium can be kept for selecting a corresponding solution.

Further, as an embodiment of the method, the method further includes:
constructing an augmented system of equations for a corresponding variable based on constraint conditions, and obtaining a solution for f(x)=0 subject to certain constraint conditions.

Further, as an embodiment of the method, the method further includes;
performing fast equation solving by using a separation method, to solve the polynomial equations for a complex solution.

Specifically, the separation method includes a variable separation method and a coefficient separation

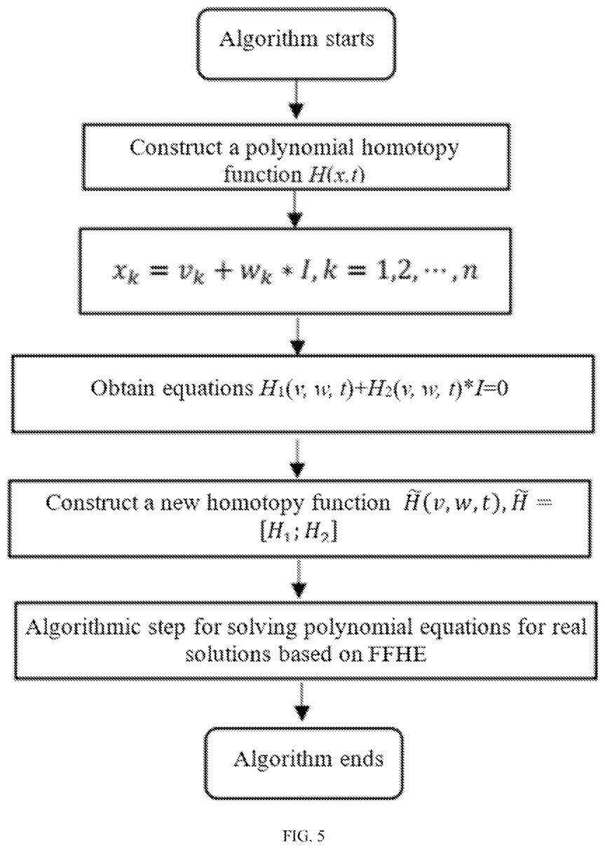

FIG. 5 shows the variable separation method for solving polynomial equations for a complex solution through fast and flexible holomorphic embedding (FFHE).

For the complex solution, separation of the homotopy function H (x, t) in step S12 into real and imaginary parts is needed, and it is specified:

xₖ=vₖ+wₖ*1,k=1,2, . . . , n; (10)

vₖ, wₖ are both real variables, and k=1,2, . . . , n; l is the imaginary unit.

These are substituted into H(x, t) =0 again, and the following equations are obtained through separation into real and imaginary parts:

H₁(v, w, t)=0, and

H₂(v, w, t)=0;

v=(v₁, v₂, . . . , vₙ)^{T}, w=(w₁w₂, . . . , wₙ)^{T}. In this case, to solve the real solutions of the polynomial equations, a step in S3 is performed for solving, and the solution is substituted into (10) to obtain a solution of the original equations.

In addition, a specific embodiment of the present invention further includes a coefficient separation method for solving a complex solution of the polynomial equations based on FFHE,

For the complex solution, separation of A and X in the linear equations in step S2 into real and imaginary parts is needed, and it is specified:

a_{q+1}^{x}^{ₖ}=a_{q+1}^{v}^{ₖ}+a_{q+1}^{w}^{ₖ}*,k=1,2, . . . , n; (11)

A is separated into A=[A₁, A₂], where A₁ is an n×n-order matrix, and A₂ is an n-dimensional column vector; and it is specified that X₁=(a_{q+1}^{x}^{₁}, . . . , a_{q+1}^{x}^{ₙ})^{T}, X_{1,R}=(a_{q+1}^{x}^{₁}, . . . , a_{q+1}^{x}^{ₙ})^{T}, X_{1,l}=(a_{q+1}^{w}^{₁}, . . . , a_{q+1}^{w}^{ₙ})^{T}, X₂a_{q+1}^{x}^{ₙ₊₁}, so that the following linear equations are obtained based on AX=b through separation into real and imaginary parts;

$$\{ \begin{matrix}{A}_{1 , R} {X}_{1 , R} - {A}_{1 , I} {X}_{1 , I} + {A}_{2 , R} {X}_{2} = {b}_{R} \\ {A}_{1 , R} {X}_{2 , I} + {A}_{1 , I} {X}_{2 , R} + {A}_{2 , I} {X}_{2} = {b}_{I}\end{matrix} ; \qquad ( 12 )$$

A_{i,R}, A_{i,I} respectively represent real and imaginary parts of Aᵢ, and i=1,2; and b_{R}, bₗ respectively represent real and imaginary parts of b.

Then, equations are generated with the arc-length parametrization equation:

$${\sum }_{k = 1}^{n} \{ {( {\sum }_{q \geq 0} ( 1 + q ) \cdot {a}_{q + 1}^{{v}_{k}} {s}^{q} )}^{2} + {( {\sum }_{q \geq 0} ( 1 + q ) \cdot {a}_{q + 1}^{{w}_{k}} {s}^{q} )}^{2} \} + {( {\sum }_{q \geq 0} ( 1 + q ) \cdot {a}_{q + 1}^{{x}_{n + 1}} {s}^{q} )}^{2} = 1 ; \qquad ( 13 )$$

The method in Which the coefficients of the same power of s are compared in a step in S2 may be used to obtain a real solution of X_{1,R}, X_{1,l}, X₂. These are substituted into (11) to obtain a complex coefficient solution of X, Another step is similar to a step in S2,

A fast and flexible holomorphic embedding apparatus for economic strategy adjustment includes;
at least one processor; and
at least one memory, configured to store at least one program, where
when the at least one program is executed by the at least one processor, the at least one processor is enabled to implement the fast and flexible holomorphic embedding method for economic strategy adjustment described above.

The content in the foregoing method embodiments is all applicable to this apparatus embodiment, Functions specifically implemented in the apparatus embodiment are the same as those in the method embodiments, with same beneficial effect achieved as beneficial effect achieved in the method embodiments,

The foregoing content is a specific description of embodiments of the present invention, but the present invention is not limited to the foregoing embodiments. A person skilled in the art may make various equivalent transformations or replacements, provided that the spirit of the present invention is not violated. These equivalent transformations or replacements shall all fall within the scope of the claims of this application.

What is claimed is:

1. A fast and flexible holomorphic embedding method for economic strategy adjustment, comprising the following steps:
S1: obtaining product data and establishing equilibrium polynomial equations based on a Bertrand
S2: describing the equilibrium polynomial equations as a polynomial system and cons meting a polynomial homotopy function;
S3: solving the equilibrium polynomial equations to obtain solutions of the equations; and
S4: analyzing equilibriums based on the solutions of the equations and performing economic strategy selection.

2. The fast and flexible holomorphic embedding method for economic strategy adjustment according to claim 1, wherein an expression of the equilibrium polynomial equations is as follows:
$$\{ \begin{matrix}{Z}^{2} {p}_{x}^{2} {p}_{y}^{2} - {p}_{x}^{2} - {p}_{y}^{2} = 0 \\ 2 {Z}^{3} {p}_{x}^{7} - 51 {Z}^{3} {p}_{x}^{6} + 5400 {Z}^{2} {p}_{x}^{3} - 8100 {Z}^{2} {p}_{x}^{2} - 2700 {p}_{x} + 2700 = 0 \\ 2 {Z}^{3} {p}_{y}^{7} - 51 {Z}^{3} {p}_{y}^{6} + 5400 {Z}^{2} {p}_{y}^{3} - 8100 {Z}^{2} {p}_{y}^{2} - 2700 {p}_{y} + 2700 = 0\end{matrix} ;$$
in the expression, each of x and y represents a corresponding product, pₓ represents a price of the product x, p_{y} represents a price of the product y, Z represents a new variable derived from pₓ and p_{y}.

3. The fast and flexible holomorphic embedding method for economic strategy adjustment according to claim 2, wherein x=(x₁, x₂, . . . , xₙ)^{T}, f(x)=[f₁(x), f₂(x), . . . , fₙ(x)]^{T}, and an expression of the polynomial homotopy function is as follows:
H(x, t)=(2−t)g(x)+(t−1)f(x);
in the expression, f (x) represents a polynomial function on the left of the equilibrium polynomial equations, and g(x) represents a preset simple function,

4. The fast and flexible holomorphic embedding method for economic strategy adjustment according to claim 3, - wherein the step of solving the equilibrium polynomial equations to obtain solutions of the equations specifically comprises:
S21: initializing and setting an order qₘₐₓ for a partial sum of a power series, a threshold ε of a mismatch tolerance for both sides of an equation, and an upper hound sₘₐₓ for an arc length of each extension, and at t=1, solving a real solution of H(x, t)=g(x) as a corresponding initial point X₀=(X₁(0), x₂(0), . . . , xₙ(0), t(0));
S22: introducing a parameter s, and selecting a normalization equation for an arc-length parametrization with the polynomial homotopy function, to construct an embedding system;
S23: providing a power series of xₖ(s), k=1,2, . . . , n, t(s) using s as a parameter and substituting the power series into the embedding system, to obtain an equation in which coefficients of a power series expansion are used as unknown variables, solving the coefficients of the power series by using a logarithmic (log) method, and performing searching-direction selection on a curve by a tangent matching principle:
S24: substituting a value of rational function at s=s₀ into the embedding system by using a method computing the value of rational function by a ratio of matrix determinants, to obtain a mismatch between values at left and right sides of the equation;
S25: reducing s o and returning to step S24 when determining that the mismatch between the values at the left and right sides of the equation is not less than a preset threshold, and repeating the process until the mismatch between the values at the, left and right sides of the equation is less than the preset threshold;
S26: recording s̅₀̅=s₀, and using xₖ(s̅₀̅)(k=1, . . . , n), t(s̅₀̅) as a new initial point X₀;
S27: determining that t≥2, solving s=s̅ when t(s)=2 and substituting s=s̅ into a latest power series expansion of xₖ, and obtaining a numerical value xₖ(s̅)(k=1, . . . , n), to obtain a solution of the equation: and S28: determining a saddle-node bifurcation point on a corresponding curve by calculating an extreme point of an approximation function of t(s),

5. The fast and flexible holomorphic embedding method - for economic strategy adjustment according to claim 4, wherein an expression of the embedding system is as follows:
$${\sum }_{k = 1}^{n} \{ {( \frac{{dx}_{k}}{ds} )}^{2} ( s ) \} + {( \frac{dt}{ds} ( s ) )}^{2} = 1 , \\ H ( x ( s ) , t ( s ) ) = 0 ;$$
in the expression, a is an arc length parameter, x =(x₁, x₂, . . . , xₙ)^{T} is a variable to be solved, and t is a variable introduced to devise a homotopy function H.

6. The fast and flexible holomorphic embedding method for economic strategy adjustment according to claim 5, wherein an expression of a power series expansion of xₖ is as follows:
xₖ(s)=Σ_{q≥0}a_{q}^{x}^{ₖ}s^{q}
in the expression, s the arc length parameter, and a_{q}^{x}^{ₖ}(q≥0) is the coefficient of the power series expansion.

7. The fast and flexible holomorphic embedding method for economic strategy adjustment according to claim 3, wherein the method further comprises:
constructing an augmented system of equations for a corresponding variable based on constraint conditions, and obtaining a solution for f(x)0 subject to certain constraint conditions.

8. The fast and flexible holomorphic embedding method for economic strategy adjustment according to claim 3, wherein the method further comprises:
performing fast equation solving by using a separation method, to solve the polynomial equations for a complex solution.

9. The fast and flexible holomorphic embedding method for economic strategy adjustment according to claim L wherein the step of analyzing equilibriums based on the solutions of the equations and performing economic strategy selection specifically comprises:
removing the negative solutions in the solutions of the equations; and
when a second-order condition for profit is satisfied and a strategy made by another given participant is also satisfied, selecting a solution that generates a maximal profit in a set of candidate equilibriums.

10. A fast and flexible holomorphic. embedding apparatus for economic strategy adjustment, comprising:
at least one processor; and
at least one memory, configured to store at least one program 1. herein
when the at least one program is executed by the at least one processor, the at least one processor is enabled to implement the fast and flexible holomorphic embedding method for economic strategy adjustment according to claim 1.
